(19) United States
(12) Patent Application Publication
(10) Pub. No.: US 2010/0323910 A1
(43) Pub. Date: Dec. 23, 2010

(54) DNA Microarray for Quantitative Detection of Microbial Processes in the Oilfield

(75) Inventors: Kenneth G. Wunch, The Woodlands, TX (US); Joseph E. Penkala, Houston, TX (US)

Correspondence Address: Mossman, Kumar and Tyler, PC, P.O. Box 421239, Houston, TX, 77242, US

(73) Assignee: Baker Hughes Incorporated, Houston, TX (US)

(21) Appl. No.: 12/695,383

(22) Filed: Jan. 28, 2010

Related U.S. Application Data
(60) Provisional application No. 61/148,672, filed on Jan. 30, 2009.

(51) Int. Cl. C40B 30/04; C40B 40/06

(52) U.S. Cl. 506/9; 506/16

(57) ABSTRACT

A DNA microarray having correctly designed target nucleotide sequences bound thereto generates a quantifiable signal when the microarray hybridizes a field sample nucleotide sequence that indicates a microbial process in a field sample from an oilfield, for instance from downhole. Such DNA microarrays may be designed and manufactured to detect microbial production of hydrogen sulfide, organic acids, surfactants, and gases as well as thermophilic bacterial activity. The field sample nucleotide sequences may be tagged with a fluorescent molecular label, so that the DNA microarrays may generate signals, such as fluorescent signals that may be measured and quantified to provide a more accurate way to correlate bacterial processes in the oilfield than presently available methods.

### CROSS-REFERENCE TO RELATED APPLICATION

This application claims the benefit of U.S. Provisional Patent Application No. 61/148,672 filed Jan. 30, 2009.

### TECHNICAL FIELD

The present invention relates to methods and apparatus for detecting and quantifying microbial processes in the oilfield, and more particularly relates, in one non-limiting embodiment, to methods and apparatus for detecting and quantifying microbial activity and processes in oilfield operations using DNA microarrays.

### BACKGROUND

Biofouling, caused by the attachment and growth of bacteria in the oil-field, as well as other industries, leads to accelerated microbiologically influenced corrosion (MIC) rates, emulsion problems, the plugging of filters, and hydrogen sulfide (H₂S) production, which is hazardous, corrosive, generates FeS scale, and eventually causes souring of the formation. Biofouling in the oilfield usually involves the formation of biofilms, which are structured communities of microorganisms encapsulated within a polymeric matrix developed by the bacteria, which film adheres to an inert surface. Current techniques used to quantify oilfield bacteria focus on microscopy to physically count all the bacteria (living and dead, with no distinction between them) in a portion of a sample or culturing the sample in “bug bottles” to quantify specific groups of bacteria. These methods have been employed in the oilfield for decades and have proven effective in discerning and enumerating relative bacterial populations. However, these methodologies, due to inherent limitations, do not satisfy the need of a growing industry with respect to expediency, accuracy and correlation to microbial problem. For example, current practices for monitoring MIC depend on either directly quantifying all bacterial cells in a sample via microscopy or culturing specific groups of bacteria, usually sulfate reducing bacteria (SRB) or acid producing bacteria (APB). However, MIC is caused by a community of bacteria in a biofilm and there is no scientific correlation between numbers and types of cells and localized corrosion. Microscopy, although reasonably accurate for counting bacteria, only covers a certain dilution range (greater than 10⁴ bacteria per ml) and cannot distinguish between live vs. dead bacteria, nor can it identify groups of bacteria or their activity. Furthermore, culture methods only recover an estimated 1% of the original population and in some cases fail to detect various organisms in the sample as in the case of thermophilic (high temperature) bacteria.

In particular, current techniques produce very inconsistent results in determining the biological activity of the organisms present. There are common reports from the field that bacteria and/or APB and SRB counts from current methods do not correlate with measured rates of H₂S production or corrosion.

Therefore, new techniques need to be developed that detect and quantify oilfield microbial processes and mechanisms.

It would thus be desirable if new methods, techniques and/or apparatus or systems would be devised to detect and quantify microbial processes in the oilfield.

### SUMMARY

There is provided, in one non-limiting form, a DNA microarray that includes an insoluble solid support and a plurality of immobilized target nucleotide sequences bound to the insoluble solid support. The target nucleotide sequences for bacterial metabolic activity that have been previously identified are selected and immobilized onto the insoluble solid support for subsequent hybridizing by the field sample nucleotide sequences. These field sample nucleotide sequences may be tagged with a molecular label to allow detection when subsequently hybridized to the immobilized target nucleotide sequences. Such bacterial metabolic activity includes, but is not necessarily limited to, cellular respiration; thermophilic bacteria activity; production of a compound which includes, but is not necessarily limited to, hydrogen sulfide, an organic acid, a surfactant, a gas, and combinations thereof; the degradation of a compound including, but not necessarily limited to, organic acids, petroleum hydrocarbons, xenobiotics and combinations thereof; enzymatic processes involved in the enhancement of the recovery or refinement of crude oil; and combinations thereof. That is, more than one bacterial metabolic activity may be detected simultaneously.

In another non-restrictive version, there is provided a DNA microarray having an insoluble solid support and a plurality of immobilized target nucleotide sequences bound to the insoluble solid support. The target nucleotide sequences are adapted to hybridize field sample nucleotide sequences previously identified with bacterial metabolic activity. Again, the bacterial metabolic activity may include, but not necessarily be limited to, cellular respiration; thermophilic bacteria activity; production of a compound including, but not necessarily limited to hydrogen sulfide, an organic acid, a surfactant, a gas, and combinations thereof; degradation of a compound including, but not necessarily limited to, organic acids, petroleum hydrocarbons, xenobiotics and combinations thereof; enzymatic processes involved in the enhancement of the recovery or refinement of crude oil; and combinations thereof. The field sample nucleotide sequences are tagged with a molecular label, and are hybridized to the target nucleotide sequences. The field sample nucleotide sequences bearing the molecular labels generate a quantifiable detectable signal.

Further, there is provided in another non-restrictive embodiment, a method of quantitative detection of microbial processes in an oilfield which involves obtaining a field sample believed to contain field sample nucleotide sequences; tagging the field sample nucleotide sequences with a molecular label that provides a detectable signal; contacting the field sample with a DNA microarray. The DNA microarray includes, but is not necessarily limited to, an insoluble solid support and a plurality of immobilized target nucleotide sequences bound to the insoluble solid support. The target nucleotide sequences are adapted to hybridize the field sample nucleotide sequences previously identified with bacterial metabolic activity. The bacterial metabolic activity includes, but is not necessarily limited to, cellular respiration; thermophilic bacteria activity; production of a compound including, but not necessarily limited to, hydrogen sulfide, an organic acid, a surfactant, a gas, and combinations thereof; degradation of a compound including, but not necessarily limited to, organic acids, petroleum hydrocarbons, xenobiotics and combinations thereof; enzymatic processes involved in the enhancement of the recovery or refinement of crude oil; and combinations thereof. The method further involves hybridizing the target nucleotide sequences with field sample nucleotide sequences bearing molecular labels adapted to generate a quantifiable detectable signal. Finally, the method involves detecting the detectable signal to quantify the bacterial metabolic activity. Again, detecting more than one bacterial metabolic activity may be performed simultaneously.

### BRIEF DESCRIPTION OF THE DRAWINGS

FIG. 1 is a schematic illustration of a large number of target nucleotide sequences on a DNA microarray, where FIG. 1A schematically shows an entire DNA microarray chip, FIG. 1B shows an enlargement of FIG. 1A showing one single location on the chip, and FIG. 1C schematically shows a still further enlargement of FIG. 1B illustrating truncated DNA strands within the single location;

FIG. 2 is a schematic illustration of a field sample nucleotide sequence that cannot hybridize with a target nucleotide sequence on the DNA microarray of FIG. 1;

FIG. 3 is a schematic illustration of two field sample nucleotide sequences that have hybridized with corresponding target nucleotide sequences on the DNA microarray of FIG. 1;

FIG. 4 is a photomicrograph of a DNA microarray, where one location has been enlarged to illustrate fluorescent intensities of various features where hybridized field sample nucleotides exist.

It will be appreciated that the drawings are not necessarily to scale or proportion and that certain elements may be exaggerated for clarity or illustration.

### DETAILED DESCRIPTION

All processes within an organism are fundamentally controlled by genes. An organism constantly senses and responds to environmental stimuli (presence of nutrients, temperature extremes, dehydration, etc.) by turning on or off genes. When genes are “turned on”, mechanisms in the cell produce molecules called messenger RNA (mRNA) which translates the DNA code of the gene into a protein. The protein helps implement or regulate a specific microbial process. The amount of protein is proportional to the number of mRNAs produced and hence to the relative activity of the gene. The more a gene is activated, the more mRNA will be produced resulting in the increased activity of a microbial process. Therefore, if the genes have been identified, a microbial process can be quantified by quantifying the amount of its specific mRNA within the cell.

Recent advances in microarray technology have allowed the development of DNA microarrays that are customizable for a specific assay. This methodology attaches thousands of copies of specific DNA sequences to a miniaturized immobilized support creating a DNA microarray. Subsequently, these microarrays then may be used to screen the genetic sequences of a given field sample. A H₂₅-detecting “PETROCHIP” may be used to quantify the SRB metabolic activity for the production of H₂S in field samples. The metabolic process for the conversion of sulfate to sulfide in SRBs has been elucidated and the genetic sequences involved have been characterized. GenBank, an open access, annotated genetic sequence database with over 100 million searchable genetic sequences, may be used to select target nucleotide sequences or probes for SRB metabolic activity.

Selected sequences to be analyzed for may be submitted to a company that has the technology to manufacture a DNA microarray chip. Such companies include, but are not limited to Affymetrix, Inc. or Eppendorf International. Affymetrix Inc. has developed a high density GENECHIP Microarray and Eppendorf has created a low density SILVERQUANT Microarray that allows for the high throughput quantification of specific mRNA. In this sense, density refers to the number of features (genetic sequences at each location), where high density refers to a relatively greater number of features relative to low density. While higher density systems may monitor more genes in comparison to the relatively lower density systems, they may be significantly more expensive.

The building of such microarrays is known, for instance, reference may be had to U.S. Pat. Nos. 7,115,364; 7,205,104 and 7,202,026, all incorporated by reference in their entirety herein. The process generally involves photolithographic binding or spotting of target nucleotide sequences to a customized DNA microarray. Such a DNA microarray may be termed a “H₂S PETROCHIP”, which would subsequently be used to correlate fluorescent values corresponding to hybridized mRNA or DNA with H₂S evolution and SRB quantification using target sequences from known SRB strains to probe field samples. It may be noted that field sample mRNA may directly hybridize with target sequence or it may be converted into cDNA (copy DNA which is more stable) to be hybridized with a target sequence. The final form of the H₂S PETROCHIP would be able to quantify field samples within a relatively short period of time, for instance, 48 hours of receipt for theoretically any type of SRB. Other PETROCHIP developments may include DNA microarrays to detect microbial activity involved in corrosion, microbial enhanced oil recovery (MEOR) and also for thermophilic bacteria or other groups of oilfield bacteria that are problematic to detect by conventional methods.

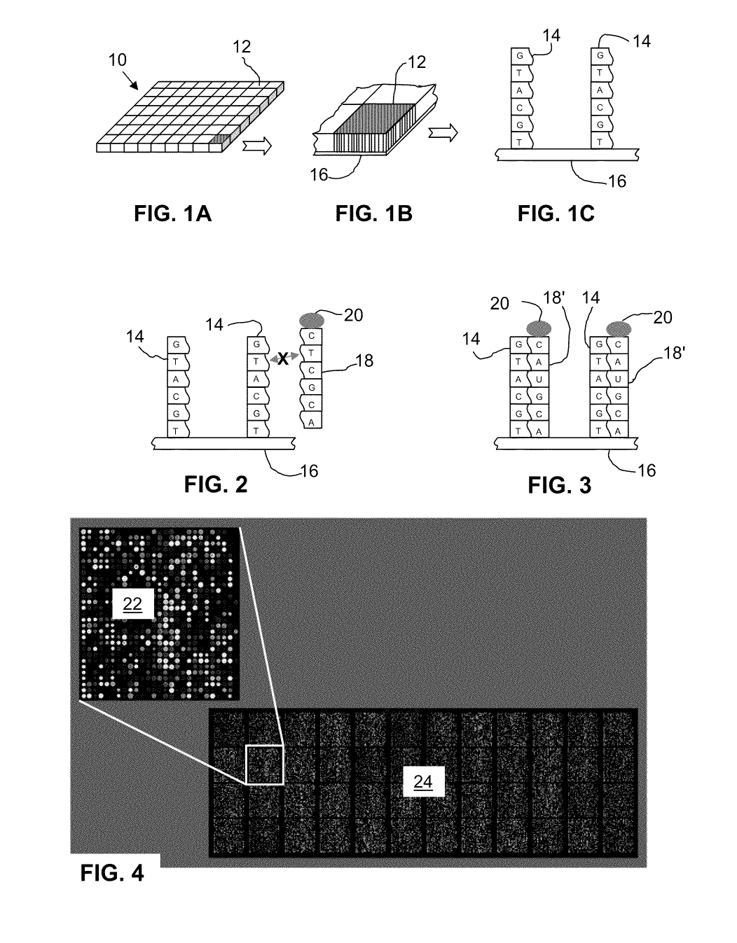

The general process may be outlined with reference to the Figures, where FIG. 1A is a schematic illustration of a single DNA microarray chip 10. The dimensions of such chips are relatively small and comparable to the “fingernail” sizes of conventional electronic integrated circuit chips. One non-limiting representative size is a square chip of about 1.3 by 1.3 centimeters (cm). Each chip 10 may contain thousands to hundreds of thousand locations 12, and each location 12 may contain up to millions of DNA strands 14, more precisely termed target nucleotide sequences 14 bound to an insoluble solid support 16. FIG. 1B schematically illustrates a single location 12. Researchers choose target genes of interest with known DNA sequences. Photolithography or other spotting techniques may be used to bind up to millions of copies of the complimentary DNA sequence (probe) 14 for that genetic sequence at each location (called a feature) 12. One non-limiting method of binding the DNA target nucleotides is by using an activated glass surface with fixed capture probes. The target nucleotide sequences or probes 14 are shown in more detail in FIG. 1C, but the sequences or probes 14 shown are much shorter than an actual strand, which may contain up to 1000 bases, in one non-limiting embodiment up to 25 bases, but in a different non-restrictive version between 50 independently up to 800 bases, where “independently” means any combination of these values as lower and upper thresholds of ranges. The six-member, shorter strands 14 shown in FIGS. 1C, 2 and 3 are to simplify the illustration.

Field samples from an oilfield, such as produced fluids from an oil well, may be collected, preserved and sent to a laboratory. mRNA or DNA (field sample nucleotide sequences) 18 from the field sample are extracted, fragmented into smaller pieces, amplified and tagged with a fluorescent label 20 and washed over the microarray 10, as schematically shown in FIG. 2. Other types of probes that may be used include, but are not necessarily limited to, radioactive labels, antibody detection methods, or metalo-detection methods for metals including, but not necessarily limited to, silver or gold. The DNA strands 14 consist of a specific sequence of nucleotide bases (A, T, G and C). The mRNA pieces 18 contain bases A, U, G and C, where U is an analog of T. Complementary pairing of bases between the DNA probe 14 and mRNA pieces 18 follows the rule that A only binds with T or U (mRNA) and G only binds with C. Thus, in the case schematically illustrated in FIG. 2, T cannot bind with T at a corresponding position.

If the tagged mRNA or DNA 18′ from the field sample complements the DNA probe in the microarray 14, then it will hybridize, or bind to, the DNA of the probe 14 as schematically illustrated in FIG. 3. The more mRNA or DNA 18′ that matches from a field sample for a given DNA probe 14, which is coated onto the microarray 10 in high abundance, the more tagged mRNA or DNA 18′ that will bind to the microarray 10. This increase in bound tagged mRNAs 18′ equates to increased fluorescent intensity of the feature (or region of the microarray with the particular immobilized target probe) 12. FIG. 4 is a photomicrograph of a single feature 22 that is part of a larger DNA microarray 24 illustrating the fluorescence. The exact map of the DNA sequences from different genes 14 on a given microarray 10 is stored in a computer program. No mRNA binding equates to no fluorescence. In the present method, this would mean that no particular microbial process would be detected.

Laser scanners or charge coupled device (CCD) sensors (or other suitable devices) may be used to read the fluorescent intensities on the chip and statistical software applications may be applied for quantification. The system would also catalog the features exhibiting fluorescence with the specific DNA nucleotide sequence corresponding to a specific gene on a given feature. Total procedural time from sample preparation to analysis may be relatively short; in a non-limiting embodiment approximately 40 hours.

### Corrosion Petrochip

Unlike bacterial H₂S production, the mechanisms and organisms involved in MIC are not completely understood. Current MIC monitoring focuses on the metabolic activity of SRBs and APBs. Genetic mechanisms for the metabolic production of the corrosive product H₂S by SRBs and organic acids by APBs are well characterized and can be utilized to develop a PETROCHIP to detect microbial processes involved in producing corrosive species and thus causing corrosion. Potential metabolic processes may be addressed that produce organic acids that include, but are not limited to, acetic acid, propionic acid, butyric acid, and the like and combinations thereof. Hybridized mRNA or DNA fluorescent values may be correlated with corrosion events and corrosion pit morphology on the metal surface using laboratory and field sample biofilms. However, since MIC is not completely understood, correlation values may be inconsistent until novel MIC mechanisms are explored. Permutations of a Corrosion PETROCHIP may also be used in research to evaluate the significance of different genes in MIC mechanisms with genetic sequences correlating to corrosion processes being incorporated into microarrays. Also, probes from both corrosion and H₂S PETROCHIPS may be combined to produce a general PETROCHIP.

### Meor Petrochip

Microbially Enhanced Oil Recovery (MEOR) involves the use of bacteria to recover additional oil from mature oil production fields, thereby enhancing the petroleum production of an oil reservoir. In this technique, selected natural microbes are introduced into oil wells and or the reservoir, or indigenous microbes are stimulated therein, to produce surfactants, polymers, solvents or gases, or other metabolites which facilitate movement of oil out of formation and/or the well. In some cases, microbes may be selected that can break down heavy oils or degrade asphaltenes and paraffins to facilitate oil recovery. MEOR is an emerging technology and is the current focus of numerous studies. Subsequently, a MEOR PETROCHIP may be developed to either monitor the natural MEOR metabolic activities from a reservoir or track the persistence of introduced microbes with superior MEOR metabolic activities. Metabolic processes that may be monitored include those that produce polymers, enzymatic processes involved in the enhancement of the recovery or refinement of crude oil and surfactants including, but not necessarily limited to, peptides, saccharides or lipids or their combinations, and gases including, but not necessarily limited to, methane (CH₄), H₂, and CO₂. Again, acids which may be detected include, but are not necessarily limited to, acetic acid and propionic acids. Solvents which may be detected include, but are not necessarily limited to acetone, ethanol, butanol, aldehydes, and combinations thereof. Polymers which may be detected include, but are not necessarily limited to, exopolysaccharides such as alginate, xanthan gum, dextran, and combinations thereof.

### Genotype Petrochip

Culture conditions for numerous groups of bacteria found in the oilfield are very difficult to simulate in the laboratory. For example, there have been several documented cases where laboratory techniques have been unsuccessful in identifying thermophilic bacteria (which may be defined as those that grow at temperatures greater than about 150° F. (about 66° C.)) from contaminated systems. Microarrays have the capacity to not only quantify specific mRNA sequences but to also quantify specific DNA sequences. Since each bacterial species contains a region with a unique DNA sequence, typically found in the 16S rRNA (ribosomal RNA) gene, species specific probes may be integrated onto a microarray chip to quantify targeted bacteria. Also, genotype probes may be combined with corrosion, H₂S and MEOR PETROCHIPS.

The invention will now be illustrated with respect to certain specific examples which are not intended to limit the invention but rather to more fully illustrate it.

The genetic analyses utilized a 16S rRNA gene microarray, the PhyloChip, which can detect 8,741 OTUs (Operational Taxonomic Units) in a single test. The PhyloChip is manufactured by AFFYMETRIX® Corporation.

### Materials and Methods

### Sample Collection and Cultivation

Produced water samples were collected from California (CA) and Wyoming (WY) in clean bottles, and each sample point was flushed thoroughly prior to sample collection. The samples were subsequently inoculated into traditional culture media and incubated at system temperature for the recommended length of time, according to industry standards (NACE Standard TM0194-2004. “Field Monitoring of Bacterial Growth in Oil and Gas Systems” (Houston, Tex.: NACE, 2004, incorporated by reference herein in its entirety). Culture media utilized were Phenol Dextrose Red for the detection of acid-producing bacteria (APB), and Modified Postgate B (PGB), West Texas (WTX), and American Petroleum Institute (API) media for the detection of sulfate-reducing bacteria (SRB). SRB and APB detection and quantification are standard monitoring tools for oil and gas field biofouling. If growth was observed, the culture vials were analyzed with the PhyloChip in the same manner as the produced water described below.

### DNA Extraction and 16S Amplification

One liter of produced water sample was filtered through a double layer of autoclaved glass filter paper. Nucleic acids were extracted directly from the filter using the method of D. G. Pitcher et al Letters Applied Microbiology 8 (1989): pp. 151-156, incorporated by reference herein in its entirety. DNA was extracted from liquid cultures by combining the two most dilute growing cultures, pelleting the cells via centrifugation and proceeding with the DNA extraction. Extracted DNA was quantified using the QUBIT™ fluorometer (available from Invitrogen Corporation). Amplification of the 16S rRNA gene pool was carried out using 2 μg of extracted DNA in quadruplicate 50 μl reactions containing 1×PCR (polymerase chain reaction) MasterMix with 0.2 μM 8F (5′-AGAGTTTGATCCTGGCTCAG-3′) and 0.2 μM primer 1492R (5′-GGTTACCTTGTTACGACTT-3′). PCR cycling was carried out as described by T. Z. DeSantis, et al., Microbial Ecology 53 (2007): pp. 371-383, incorporated by reference herein in its entirety. Amplicons were concentrated using the Montage PCR concentrator column.

### Microarray Analysis

Fragmentation, labeling and hybridization of 16S amplicons to the G2 PhyloChip was carried out according to the methods of Desantis et al. (noted above). A probe pair was scored as positive if the fluorescence intensity of the perfect match probe was at least 1.3 times greater than the intensity of the mismatch probe and the difference between the perfect match and mismatch intensities were 130 times greater than the square of the background intensity. An OTU was scored as positive if the positive fraction (pf) of a probe set was greater than or equal to 0.92. Initial community analysis was performed using the PhyloTrac software package (http://www.phylotrac.org).

### Results and Discussion

Produced water samples from CA and WY and their cultured contents were analyzed with the PhyloChip in order to ascertain the ability of the culture media to accurately cultivate, and therefore detect, the bacteria within that produced water sample.

The sample from CA was cultivated in all four media. For classification purposes, microorganisms that are classified as SRB comprise several groups of bacteria that use sulfate as an oxidizing agent, reducing it to sulfide. Those that are designated as APB comprise a variety of heterotrophic bacteria that share the common ability to produce organic acidic products when growing under reductive conditions. Table 1 contains the recovery of the APB Orders from CA field sample in comparison to APB standard culture media. Of the 194 Orders of APB detected in the produced water sample, the APB medium was able to cultivate 73, yielding a 37.6% recovery rate.

TABLE 1
Recovery of APB Orders from CA Field Sample in
Comparison to APB Standard Culture Media

| | Number of isolates from | Number of isolates |
|---|---|---|
| Bacterial Order | field sample | from APB culture |
| Sphingobacteriales | 10 | 5 |
| Bacteroidales | 16 | 11 |
| Flavobacteriales | 5 | 3 |
| Clostridiales | 102 | 33 |
| Lactobacillales | 2 | 0 |
| Enterobacteriales | 4 | 2 |
| Pseudomonadales | 13 | 9 |
| Acetobacterales | 2 | 1 |
| Acidobacteriales | 20 | 8 |
| Bifidobacteriales | 2 | 0 |
| Spirochaetales | 16 | 1 |
| Total Recovery | 194 | 73 (37.6%) |

Table 2 contains the recovery rate of the SRB Families from CA field sample in comparison to WTX, API, and PGB SRB culture media. Of the 62 SRB Families detected in the produced water sample, WTX media was able to cultivate 8 (12.9% recovery rate), API 2 (3.2% recovery rate), and PGB 9 (14.5% recovery rate). The total culture recovery rate was 17.7%, however, no one media was able to recover more than 14.5% of SRB Families present.

TABLE 2
Recovery of SRB Families from CA Field Sample in
Comparison to WTX, API, and PGB SRB Culture Media

| | | Number | | | Total |
|---|---|---|---|---|---|
| | Number | of isolates | Number | Number | Family |
| | of isolates | from | of isolates | of isolates | recovery |
| | from field | WTX | from API | from PGB | from |
| Bacterial Family | sample | culture | culture | culture | culture |
| Thermodesulfobacteriaceae | 1 | 0 | 0 | 0 | 0 |
| Peptococcaceae | 17 | 0 | 0 | 0 | 0 |
| Syntrophomonadaceae | 8 | 1 | 0 | 2 | 2 |
| Nitrospinaceae | 1 | 0 | 0 | 0 | 0 |
| Desulfoarculaceae | 4 | 0 | 0 | 0 | 0 |
| Desulfobacteraceae | 10 | 1 | 0 | 0 | 1 |
| Desulfobulbaceae | 6 | 0 | 0 | 0 | 0 |
| Geobacteraceae | 1 | 0 | 0 | 0 | 0 |
| Desulfuromonaceae | 2 | 0 | 0 | 0 | 0 |
| Desulfomicrobiaceae | 2 | 1 | 0 | 1 | 1 |
| Desulfohalobiaceae | 2 | 0 | 0 | 1 | 1 |
| Desulfovibrionaceae | 8 | 5 | 2 | 5 | 6 |
| Total Recovery | 62 | 8 (12.9%) | 2 (3.2%) | 9 (14.5%) | 11 (17.7%) |

The sample from WY was not culturable in any of the mediums; however, the presence of bacteria was strongly suspected. This discrepancy is occasionally encountered in oil and gas production fluids. Tables 3 and 4 depict the 22 APB Orders and 9 SRB Families detected in the produced water as detected by the PhyloChip. The differing culture media were unable to cultivate any of those microorganisms, yielding a 0% recovery rate.

TABLE 3
Recovery of APB Orders from WY field sample in
Comparison to APB Standard Culture Media

| | Number of isolates | Number of isolates |
|---|---|---|
| Bacterial Order | from field sample | from APB culture |
| Sphingobacteriales | 7 | 0 |
| Clostridiales | 4 | 0 |
| Thermodesulfobacteriales | 1 | 0 |
| Acidobacteriales | 6 | 0 |
| Spirochaetales | 3 | 0 |
| Total Recovery | 22 | 0 (0.0%) |

TABLE 4
Recovery of SRB Families from WY Field Sample in
Comparison to WTX, API, and PGB SRB Culture Media

| | | Number | Number | Number | |
|---|---|---|---|---|---|
| | Number of | of | of | of | Total |
| | isolates | isolates | isolates | isolates | Family |
| | from | from | from | from | recovery |
| | field | WTX | API | PGB | from |
| Bacterial Family | sample | culture | culture | culture | culture |
| Thermodesulfobacteriaceae | 1 | 0 | 0 | 0 | 0 |
| Thermodesulfobiaceae | 1 | 0 | 0 | 0 | 0 |
| Syntrophomonadaceae | 3 | 0 | 0 | 0 | 0 |
| Desulfobulbaceae | 2 | 0 | 0 | 0 | 0 |
| Desulfohalobiaceae | 1 | 0 | 0 | 0 | 0 |
| Total Recovery | 9 | 0 (0.0%) | 0 (0.0%) | 0 (0.0%) | 0 (0.0%) |

These results illustrate one of the fundamental problems of oil field culturfing techniques: the large discrepancy between what is cultivated and detected in culture media as compared to what is actually present in the oil and gas field environment. Others have also found the traditional analysis of gas pipeline samples by using cultivation in growth media for specific types of bacteria may yield misleading results, as the retrieved sequences showed that the dominant species in the gas pipeline environment and those from SRB growth media were different. Other issues with the use of culture mediums include the long incubation periods necessary for cultivation, the necessity of media optimization in terms of salinity and nutrients, and the occurrence of skewed results when bacteria adapt and alter their wild type metabolism to survive and thrive in an artificial environment. As illustrated here, it is possible for the microbial population of an area to be completely unculturable and therefore they are often not detected until system upsets occur. Furthermore, the cultivation of bacteria from these often extreme environments is difficult, if not impossible, and may lead to incorrect conclusions regarding the diversity and metabolic activity of the microbial consortium and, thus, to improper design of control strategies.

While one focus of this study was on the efficacy of culture media, it is important to note that molecular methods can also have gross inaccuracies, as well. While no one method is perfect and care must be taken when using any one method alone, it is becoming increasingly clear that molecular methods of detection and enumeration are superior to the traditional culture-dependent methods.

It is believed that this is the first use of the PhyloChip microarray analysis in an oil or gas environment. One intent of this study is to illustrate the inadequacy of commonly used culture-dependent means to identify possibly problematic microorganisms. The PhyloChip was not designed specifically for this industry and thus many oil- and gas-associated microorganisms are likely not targeted by this array. The oil and gas field microbial populations are quite different from those of soil and it will be necessary to build a database of probes specific for this application. Thus, the results here may not represent the actual culture analysis recovery rate. In addition, the majority of our problematic bacteria and archae in oilfield systems are yet to be sequenced, and this is a major hindrance to the progression and accuracy of molecular microbial detection and enumeration. Nevertheless, these experiments and data prove the concept of the method described herein.

In the foregoing specification, it will be evident that various modifications and changes may be made thereto without departing from the broader spirit or scope of the invention as set forth in the appended claims. Accordingly, the specification is to be regarded in an illustrative rather than a restrictive sense. For example, target nucleotide sequences to detect genes in the oilfield other than those mentioned, but not specifically identified or tried in a particular method or composition, are anticipated to be within the scope of this invention. Further, it will be appreciated that more than one field sample nucleotide sequence may be addressed with a single microarray, in a non-limiting instance a gas such as H₂S and a particular organic acid with the purpose of addressing more than one corrosion mechanism. Additionally, DNA microarrays that fall within the methods and apparatus herein, but that are made by different processing that those specifically outlined are also within the scope of the invention herein.

The present invention may suitably comprise, consist or consist essentially of the elements disclosed and may be practiced in the absence of an element not disclosed.

The words “comprising” and “comprises” as used throughout the claims is to interpreted “including but not limited to”.

What is claimed is:

1. A DNA microarray comprising:
an insoluble solid support; and
a plurality of immobilized target nucleotide sequences bound to the insoluble solid support, where the target nucleotide sequences are adapted to hybridize field sample nucleotide sequences previously identified with bacterial metabolic activity selected from the group consisting of:
cellular respiration;
thermophilic bacteria activity;
production of a compound selected from the group consisting of an organic acid, a surfactant, a polymer, a solvent, a gas, and combinations thereof;
degradation of a compound selected from the group consisting of organic acids, petroleum hydrocarbons, xenobiotics and combinations thereof;
enzymatic processes involved in the enhancement of the recovery or refinement of crude oil; and
combinations thereof.

2. The DNA microarray of claim 1 where:
the organic acid is selected from the group consisting of acetic acid, propionic acid, butyric acid and combinations thereof;
the surfactant is selected from the group consisting of peptides, saccharides, lipids, and combinations thereof;
the gas is selected from the group consisting of CH₄, H₂, CO₂ and combinations thereof;
the solvents are selected from the group consisting of acetone, ethanol, butanol, aldehydes and combinations thereof; and
the polymers are exopolysaccharides selected from the group consisting of alginate, xanthan gum, dextran, and combinations thereof.

3. The DNA microarray of claim 1 where the molecular label is fluorescent and where the quantifiable detectable signal is fluorescence.

4. A DNA microarray comprising:
an insoluble solid support;
a plurality of immobilized target nucleotide sequences bound to the insoluble solid support, where the target nucleotide sequences are adapted to hybridize field sample nucleotide sequences previously identified with bacterial metabolic activity selected from the group consisting of:
cellular respiration;
thermophilic bacteria activity;
production of a compound selected from the group consisting of an organic acid, a surfactant, a polymer, a solvent, a gas, and combinations thereof;
degradation of a compound selected from the group consisting of organic acids, petroleum hydrocarbons, xenobiotics and combinations thereof;
enzymatic processes involved in the enhancement of the recovery or refinement of crude oil;
and combinations thereof;
and where the field sample nucleotide sequences are tagged with a molecular label; and
field sample nucleotide sequences hybridized to the target nucleotide sequences, where the field sample nucleotide sequences bearing the molecular labels generate a quantifiable detectable signal.

5. The DNA microarray of claim 4 where:
the organic acid is selected from the group consisting of acetic acid, propionic acid, butyric acid and combinations thereof;
the surfactant is selected from the group consisting of peptides, saccharides, lipids, and combinations thereof;
the gas is selected from the group consisting of CH₄, H₂, CO₂ and combinations thereof;
the solvents are selected from the group consisting of acetone, ethanol, butanol, aldehydes and combinations thereof; and
the polymers are exopolysaccharides selected from the group consisting of alginate, xanthan gum, dextran and combinations thereof.

6. The DNA microarray of claim 1 where the molecular label is fluorescent and where the quantifiable detectable signal is fluorescence.

7. A method of quantitative detection of microbial processes in an oilfield comprising:
obtaining a field sample believed to contain field sample nucleotide sequences;
tagging the field sample nucleotide sequences with a molecular label that provides a detectable signal;
contacting the field sample with a DNA microarray that comprises:
an insoluble solid support; and
a plurality of immobilized target nucleotide sequences bound to the insoluble solid support, where the target nucleotide sequences are adapted to hybridize the field sample nucleotide sequences previously identified with bacterial metabolic activity selected from the group consisting of:
cellular respiration;
thermophilic bacteria activity;
production of a compound selected from the group consisting of an organic acid, a surfactant, a polymer, a solvent, a gas, and combinations thereof;
degradation of a compound selected from the group consisting of organic acids, petroleum hydrocarbons, xenobiotics and combinations thereof;
enzymatic processes involved in the enhancement of the recovery or refinement of crude oil; and
combinations thereof;
hybridizing the target nucleotide sequences with field sample nucleotide sequences bearing molecular labels adapted to generate a quantifiable detectable signal; and
detecting the detectable signal to quantify the bacterial metabolic activity.

8. The method of claim 7 where:
the organic acid is selected from the group consisting of acetic acid, propionic acid, butyric acid and combinations thereof;
the surfactant is selected from the group consisting of peptides, saccharides, lipids, and combinations thereof;
the gas is selected from the group consisting of CH₄, H₂, CO₂ and combinations thereof;
the solvents are selected from the group consisting of acetone, ethanol, butanol, aldehyde and combinations thereof; and
the polymers are exopolysaccharides selected from the group consisting of alginate, xanthan gum, dextran and combinations thereof.

9. The method of claim 7 where the quantifiable detectable signal is fluorescence.


SEQUENCE LISTING (25 sequences)

SEQ ID NO: 1 - DNA, 19 bp, Artificial Sequence
  chemically synthesized
gygagtggkcctgctayga

SEQ ID NO: 2 - DNA, 18 bp, Artificial Sequence
  chemically synthesized
ccaggtgccgataacrgc

SEQ ID NO: 3 - DNA, 19 bp, Artificial Sequence
  chemically synthesized
cgacacccargacatgtgc

SEQ ID NO: 4 - DNA, 20 bp, Artificial Sequence
  chemically synthesized
gcwgctacgcaaccgttggg

SEQ ID NO: 5 - DNA, 20 bp, Artificial Sequence
  chemically synthesized
ctgcgaatatgcctgctaca

SEQ ID NO: 6 - DNA, 19 bp, Artificial Sequence
  chemically synthesized
ggggcarccgtcgaacttg

SEQ ID NO: 7 - DNA, 20 bp, Artificial Sequence
  chemically synthesized
acscactggaagcacggcgg

SEQ ID NO: 8 - DNA, 19 bp, Artificial Sequence
  chemically synthesized
gtggmrccgtgcakrttgg

SEQ ID NO: 9 - DNA, 20 bp, Artificial Sequence
  chemically synthesized
agagtttgatcctggctcag

SEQ ID NO: 10 - DNA, 18 bp, Artificial Sequence
  chemically synthesized
cggcgtcgctgcgtcacg

SEQ ID NO: 11 - DNA, 18 bp, Artificial Sequence
  chemically synthesized
cggcgtcgctgcgtcacg

SEQ ID NO: 12 - DNA, 18 bp, Artificial Sequence
  chemically synthesized
cggcgttgctgcgtcagg

SEQ ID NO: 13 - DNA, 20 bp, Artificial Sequence
  chemically synthesized
gttcctccagatatctacgg

SEQ ID NO: 14 - DNA, 18 bp, Artificial Sequence
  chemically synthesized
cctgtgctccatgctccg

SEQ ID NO: 15 - DNA, 18 bp, Artificial Sequence
  chemically synthesized
actcctacgggaggcagc

SEQ ID NO: 16 - DNA, 20 bp, Artificial Sequence
  chemically synthesized
acggggygcagcaggcgcga

SEQ ID NO: 17 - DNA, 20 bp, Artificial Sequence
  chemically synthesized
ctgctcccccgccaattcct

SEQ ID NO: 18 - DNA, 22 bp, Artificial Sequence
  chemically synthesized
ccgggccgtaaccgtccttgaa

SEQ ID NO: 19 - DNA, 22 bp, Artificial Sequence
  chemically synthesized
ccgggccgtaaccgtccttgaa

SEQ ID NO: 20 - DNA, 22 bp, Artificial Sequence
  chemically synthesized
tagcggtgraatgygttgatcc

SEQ ID NO: 21 - DNA, 18 bp, Artificial Sequence
  chemically synthesized
agcaccacaacgcgtgga

SEQ ID NO: 22 - DNA, 24 bp, Artificial Sequence
  chemically synthesized
tycgacagtgaggracgaaagctg

SEQ ID NO: 23 - DNA, 21 bp, Artificial Sequence
  chemically synthesized
agggaagccgtgaagcgarcc

SEQ ID NO: 24 - DNA, 18 bp, Artificial Sequence
  chemically synthesized
ttagcaagggccgggcaa

SEQ ID NO: 25 - DNA, 22 bp, Artificial Sequence
  chemically synthesized
acggcaagggacgaaagctagg